(19) United States
(12) Patent Application Publication
(10) Pub. No.: US 2023/0134236 A1
(43) Pub. Date: May 4, 2023

(54) REACTOR CORE

(71) Applicant: MITSUBISHI HEAVY INDUSTRIES, LTD., Tokyo (JP)

(72) Inventors: Hiromichi Gima, Tokyo (JP); Yukinori Usui, Tokyo (JP); Hiroshi Sakaba, Tokyo (JP); Taro Kan, Tokyo (JP)

(73) Assignee: MITSUBISHI HEAVY INDUSTRIES, LTD., Tokyo (JP)

(21) Appl. No.: 17/918,478

(22) PCT Filed: Apr. 27, 2021
(86) PCT No.: PCT/JP2021/016774

§ 371 Date: Oct. 12, 2022

(30) Foreign Application Priority Data
Apr. 28, 2020 (JP) 2020-079438

(51) Int. Cl. G21C 1/02; G21C 7/34

(52) U.S. Cl. CPC G21C 1/024; G21C 7/34

(57) ABSTRACT

A reactor core includes an inner core region that extends in a vertical direction, and has a plurality of first fuel pins accommodating an inner core fuel; an outer core region that extends in the vertical direction, is arranged to surround the inner core region from an outer peripheral side, and has a plurality of second fuel pins accommodating an outer core fuel; and a sodium plenum provided above the inner core region and the outer core region, in which a dimension of the outer core fuel in the vertical direction is larger than a dimension of the inner core fuel in the vertical direction, and the position of a center of the outer core fuel in the vertical direction is higher than the position of a center of the inner core fuel in the vertical direction.

### TECHNICAL FIELD

This present disclosure relates to a reactor core.

Priority is claimed on Japanese Patent Application No. 2020-079438, filed Apr. 28, 2020, the content of which is incorporated herein by reference.

### BACKGROUND ART

As a type of a nuclear reactor, a type called a sodium-cooled fast reactor shown in Patent Document 1 below has been put into practical use. The reactor core of the sodium-cooled fast reactor is configured by a plurality of fuel assemblies loaded with fissile materials, and liquid metal sodium as a coolant for removing heat generated from the fuel assemblies.

In a case where a metal fuel is used for the fuel assembly, a cast metal fuel is generally used. The fuel assembly has a cylindrical wrapper tube (cladding tube), and a plurality of fuel pins accommodated inside the wrapper tube. The metal fuel as the fissile material and liquid metal sodium are enclosed in the inside of the fuel pin.

Here, as an index for evaluating the safety and stability of the reactor core, an index called a void reactivity (void coefficient of reactivity) is known. The void reactivity is a value that depends on a generation amount (void amount) of bubbles in the coolant in the reactor core. In a case where the temperature of the coolant in the reactor core is increased, the density of the coolant is decreased. As a result of the decrease in the density, the energy of neutrons is less likely to be absorbed by the coolant, and the neutrons are less likely to be decelerated. This causes a positive void reactivity, and may impair the stability of the reactor core.

In order to cancel such a positive void reactivity, for example, a method of reducing the reactor core height and providing a sodium plenum above the reactor core to promote neutron leakage to the outside of the reactor core can be considered.

### CITATION LIST

### Patent Document

[Patent Document 1]

Japanese Unexamined Patent Application, First Publication No. H5-323077

### SUMMARY OF INVENTION

### Technical Problem

However, as described above, in the fuel assembly using a cast metal fuel in the related art, since the liquid metal sodium has to be loaded between the fuel and the cladding tube, a space (gas plenum) for releasing gas generated by nuclear fission needs to be arranged above the fuel. Therefore, it is not possible to secure a space for providing the sodium plenum in an upper portion. As a result, there are restrictions on improving the passive safety characteristics of the reactor core.

The present disclosure has been made to solve the above problems, and an object of the present disclosure is to provide a reactor core having higher stability.

### Solution to Problem

In order to solve the above problems, a reactor core according to the present disclosure includes an inner core region that extends in a vertical direction, and has a plurality of first fuel pins accommodating an inner core fuel; an outer core region that extends in the vertical direction, is arranged to surround the inner core region from an outer peripheral side, and has a plurality of second fuel pins accommodating an outer core fuel; and a sodium plenum provided above the inner core region and the outer core region, in which a dimension of the outer core fuel in the vertical direction is larger than the dimension of the inner core fuel in the vertical direction, and the position of a center of the outer core fuel in the vertical direction is higher than the position of a center of the inner core fuel in the vertical direction.

### Advantageous Effects of Invention

According to the present disclosure, it is possible to provide a reactor core having higher stability.

### BRIEF DESCRIPTION OF DRAWINGS

FIG. 1 is a vertical sectional view showing a configuration of a fast reactor according to an embodiment of the present disclosure.

FIG. 2 is a plan view showing a configuration of a reactor core according to the embodiment of the present disclosure.

FIG. 3 is a vertical sectional view showing a configuration of a fuel assembly according to the embodiment of the present disclosure.

FIG. 4 is a schematic sectional view showing a configuration of the reactor core according to the embodiment of the present disclosure.

FIG. 5 is a graph showing a distribution of neutron flux in a vertical direction of the reactor core according to the embodiment of the present disclosure.

### DESCRIPTION OF EMBODIMENTS

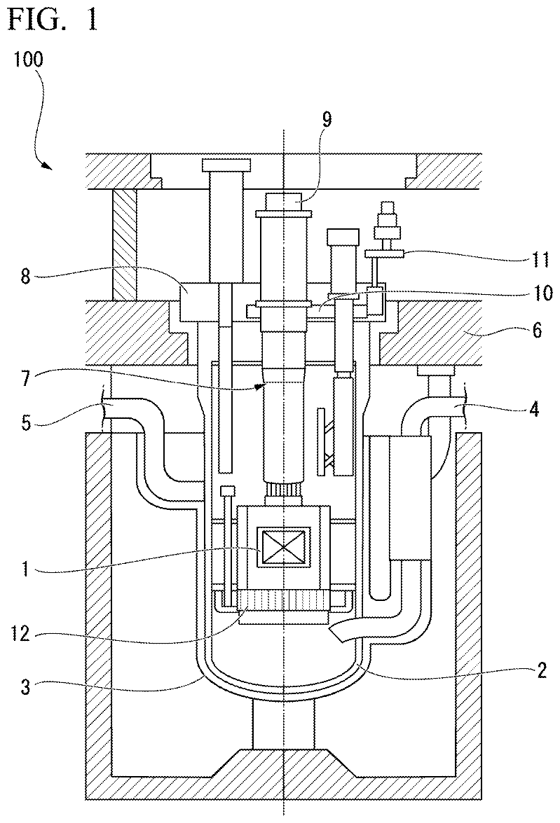

Hereinafter, a fast reactor 100 and a reactor core 1 according to an embodiment of the present disclosure will be described with reference to FIGS. 1 to 5.

(Configuration Example of Fast Reactor)

The fast reactor uses mixed oxide of uranium (U) and plutonium (Pu) as a fuel to fission Pu239, while allowing U238 to absorb generated excess fast neutrons and produce more plutonium than being burned. As shown in FIG. 1, the fast reactor 100 includes the reactor core 1, a reactor vessel 2, a guard vessel 3, a coolant inlet pipe 4, a coolant outlet pipe 5, an upper core structure 7, and a fixed plug 8.

The reactor core 1 is a heat generation source containing a fissile material. The detailed configuration of the reactor core 1 will be described later. The reactor vessel 2 is a vessel that accommodates the reactor core 1. The reactor vessel 2 has a cylindrical shape having a bottom surface. The reactor core 1 is fixed to a lower portion in the reactor vessel 2 via a core internal structure 12. The opening at an upper portion of the reactor vessel 2 is covered by the fixed plug 8. The fixed plug 8 is supported by the structure of a nuclear reactor building (reactor vessel pedestal 6).

The guard vessel 3 covers the reactor vessel 2 from the outside. That is, the reactor vessel 2 and the guard vessel 3 form a double wall structure. As a result, even in a case where the coolant leaks from the reactor vessel 2, the coolant is held by the guard vessel 3, and leakage to the outside is suppressed.

The coolant inlet pipe 4 guides liquid metal sodium as the coolant (primary coolant) guided from the outside, into the reactor vessel 2. The end portion of the coolant inlet pipe 4 is positioned below the reactor core 1 in the reactor vessel 2. As a result, the inside of the reactor vessel 2 is in a state of being filled with the coolant. The coolant outlet pipe 5 discharges the coolant in the reactor vessel 2 to the outside. The end portion of the coolant outlet pipe 5 is positioned above the reactor core 1 in the reactor vessel 2.

The upper core structure 7 has a control rod drive mechanism 9, a rotary plug 10, and a rotary plug drive device 11. The control rod drive mechanism 9 is a device for inserting and pulling out a control rod for controlling the progress of the fission reaction in the reactor core 1 described later. The control rod drive mechanism 9 moves the control rod up and down in the vertical direction. The rotary plug 10 is a device for positioning a device for exchanging the nuclear fuel (fuel assembly 30 described later) in the reactor core 1. The rotary plug 10 is driven by the rotary plug drive device 11.

(Configuration of Reactor Core)

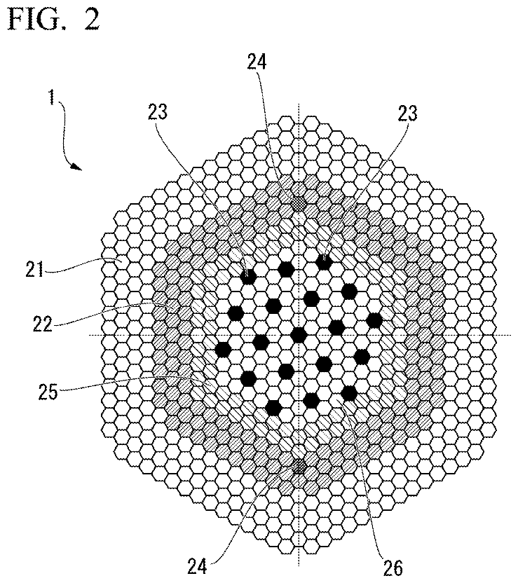

Next, the configuration of the reactor core 1 will be described with reference to FIG. 2. As shown in FIG. 2, the reactor core 1 is an assembly of members each having a hexagonal sectional shape, and is arranged without gaps to form a hexagonal shape as a whole. The reactor core 1 has a neutron shield 21, a radial blanket fuel 22, a control rod 23, a neutron source 24, an outer core region 25, and an inner core region 26.

The neutron shield 21 is arranged on the outermost peripheral side of the reactor core 1. A plurality of neutron shields 21 are arranged so as to form a hexagonal annular shape. A plurality of radial blanket fuels 22 are arranged inside the neutron shield 21. The radial blanket fuels 22 are arranged in a hexagonal annular shape. The outer core region 25 is provided inside the radial blanket fuel 22. The inner core region 26 is provided further inside the outer core region 25. A plurality of control rods 23 can be inserted into a partial region in the inner core region 26. The outer core region 25 and the inner core region 26 are formed by arranging a plurality of fuel assemblies 30 described later.

The outer core region 25 and the inner core region 26 generate heat by fission of the fissile material triggered by the neutrons generated from the neutron source 24. The insertion amount of the control rod 23 is adjusted to control the progress of the fission reaction. In the radial blanket fuel 22, the reaction progresses in a state where the fast fission reaction is reduced as compared with the outer core region 25 and the inner core region 26. Further, in the radial blanket fuel 22, the absorption amount of neutrons generated by the fission reaction is larger than that in the outer core region 25 and the inner core region 26. The neutron shield 21 is provided to shield the neutrons and suppress leakage to the outside.

(Configuration of Fuel Assembly)

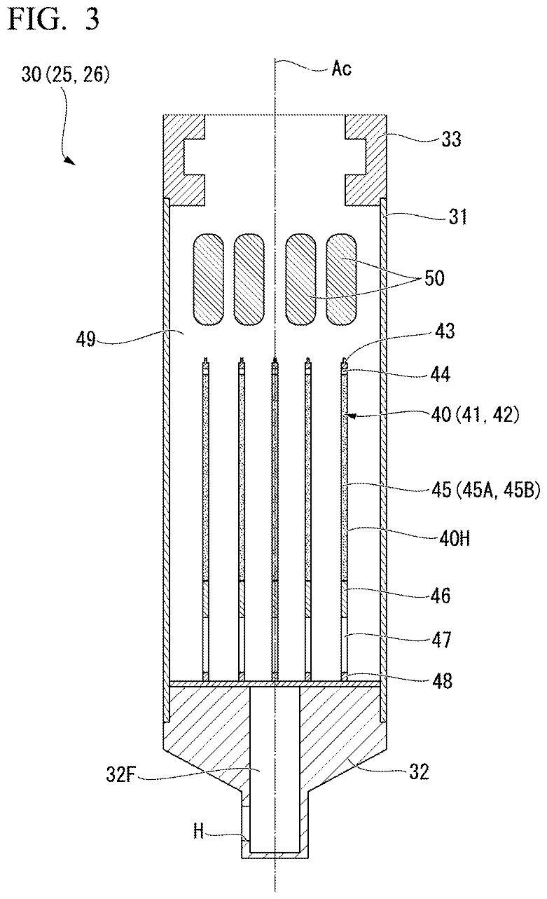

Subsequently, the configuration of the fuel assembly 30 will be described with reference to FIG. 3. The fuel assembly 30 has a wrapper tube 31, an entrance nozzle 32, a handling head 33, a plurality of fuel pins 40 (first fuel pin 41, second fuel pin 42), and an upper neutron shield 50.

The wrapper tube 31 has a cylindrical shape centered on an axis line Ac extending in the vertical direction. Further, the wrapper tube 31 has a hexagonal sectional shape when viewed from the axis line Ac direction. The opening at a lower portion of the wrapper tube 31 is closed by the entrance nozzle 32. In the inside of the entrance nozzle 32, a flow path 32F for guiding the coolant into the inside of the wrapper tube 31 is formed. An inlet H for the communication between the flow path 32F and the outside is formed in the lower portion of the entrance nozzle 32. The handling head 33 is attached to the opening at the upper portion of the wrapper tube 31. The handling head 33 is a portion gripped by the device when the fuel assembly 30 is transported.

The plurality of fuel pins 40 are arranged inside the wrapper tube 31 and directly above the entrance nozzle 32, at intervals in a direction orthogonal to the axis line Ac. Each fuel pin 40 has a cylindrical pin body 40H extending in the vertical direction, an upper end plug 43 that closes the upper opening of the pin body 40H, a lower end plug 48 that closes the lower opening of the pin body 40H, fuel alloy particles 45 (core fuel) enclosed inside the pin body 40H, and a lower blanket fuel 46. The fuel alloy particles 45 are formed of fissile metal particles having two types of different outer diameters. The fuel alloy particles 45 are filled in a region upwardly biased in the pin body 40H.

As will be described in detail later, the configuration of the fuel assembly 30 is different between the outer core region 25 and the inner core region 26. Specifically, in the fuel pin 40 (second fuel pin 42) constituting the outer core region 25, the dimensions of the fuel alloy particles 45 in the vertical direction are large as compared with the fuel pin 40 (first fuel pin 41) constituting the inner core region 26. That is, the fuel alloy particles 45 (outer core fuel 45B) of the second fuel pin 42 are set to have a larger dimension in the vertical direction than the fuel alloy particles 45 (inner core fuel 45A) of the first fuel pin 41.

The space between the fuel alloy particles 45 and the upper end plug 43 is an upper gas plenum 44 through which the gas generated from the fuel alloy particles 45 flows. A heat shield (not shown) is provided in the upper gas plenum 44. The lower blanket fuel 46 formed of depleted uranium is filled below the fuel alloy particles 45. It is also possible to adopt a configuration in which the lower blanket fuel 46 is not provided. Further, the second fuel pin 42 constituting the outer core region 25 does not include the lower blanket fuel 46.

The space above the lower end plug 48 is a lower gas plenum 47 through which the gas generated from the fuel alloy particles 45 flows. The dimension of the lower gas plenum 47 in the vertical direction is larger than the dimension of the upper gas plenum 44. The upper neutron shield 50 is provided to shield the leakage of neutrons upward. The upper neutron shield 50 is arranged above the fuel pin 40 with a gap.

The space around and above the fuel pin 40 configured as described above is a sodium plenum 49. The liquid metal sodium as the coolant guided from the inlet H of the entrance nozzle 32 flows to the sodium plenum 49.

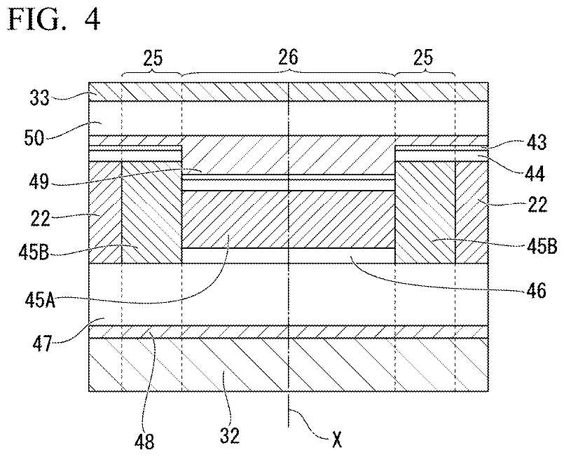

Next, with reference to FIG. 4, the difference in the dimensions of the outer core region 25 and the inner core region 26 in the vertical direction will be described. FIG. 4 shows a cross section including a central axis line X of the reactor core 1. Further, in FIG. 4, the illustration of the neutron shield 21 in FIG. 2 is omitted. As shown in FIG. 4, the dimension of the outer core fuel 45B in the outer core region 25 in the vertical direction is larger than the dimension of the inner core fuel 45A of the inner core region 26 in the vertical direction. Further, the upper end of the outer core fuel 45B is at a higher position than the upper end of the inner core fuel 45A. Further, as described above, the fuel pin 40 constituting the outer core region 25 is not provided with the lower blanket fuel 46. As a result, the lower end of the inner core fuel 45A is at a higher position than the lower end of the outer core fuel 45B.

(Effects)

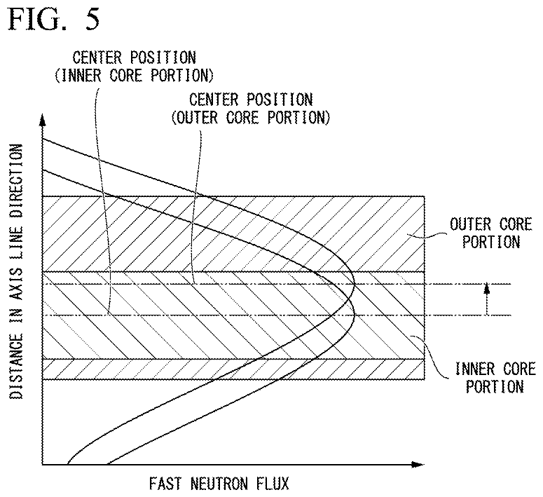

Here, as shown in FIG. 5, it is known that the peak position of the fast neutron flux (that is, the position with the largest number of fast neutrons passing per unit area and unit time) generated from the inner core fuel 45A and the outer core fuel 45B is the center position in the vertical direction of each core fuel. With the above configuration, the dimension of the outer core fuel 45B in the vertical direction is larger than the dimension of the inner core fuel 45A in the vertical direction. Further, the position of the center of the outer core fuel 45B is higher than the position of the center of the inner core fuel 45A. That is, the peak position of the fast neutron flux generated from the outer core fuel 45B can be maintained above the peak position of the fast neutron flux generated from the inner core fuel 45A. As a result, it is possible to secure a large amount of neutron leakage to the sodium plenum 49 positioned above the inner core fuel 45A and the outer core fuel 45B. As a result, even in a case where the temperature of the coolant is abnormally increased, a large negative reactivity can be generated. Therefore, the passive safety of the reactor core 1 is further improved, and the fast reactor 100 can be operated more safely.

Further, with the above configuration, the upper end of the outer core fuel 45B is at a position higher than the upper end of the inner core fuel 45A. That is, the peak position of the fast neutron flux generated from the outer core fuel 45B can be maintained above the peak position of the fast neutron flux generated from the inner core fuel 45A. As a result, the amount of neutron leakage to the sodium plenum 49 positioned above the inner core fuel 45A and the outer core fuel 45B can be further secured.

On the other hand, with the above configuration, the dimension of the outer core fuel 45B is larger than the dimension of the inner core fuel 45A in the downward direction as well as in the upward direction. As a result, the heat generation range of the outer core fuel 45B is widened, and more output can be generated. That is, by keeping the height dimension of the inner core fuel 45A small and by increasing the output sharing of the outer core fuel 45B, the average output and peak output of the fuel can be suppressed without increasing the number of loads of the fuel assembly 30 and without increasing the radial dimension of the reactor core 1. That is, it is possible to suppress the increase in the size of the reactor core system caused by flattening.

Further, with the above configuration, since the fuel alloy particles 45 are used as the fissile material, it is not necessary to enclose sodium inside the pin body 40H. Therefore, a gas plenum (that is, a region filled with the inert gas), which is provided above the fuel alloy particles 45 in the related art, can be provided below the fuel alloy particles 45. Further, dimensions of the first fuel pin 41 and the second fuel pin 42 in the vertical direction can be suppressed to be small by the amount that the region to be filled with sodium is eliminated and the amount that the gas pressure is suppressed to be low by installing the gas plenum below the fuel alloy particles 45. As a result, the size of the reactor core 1 can be reduced.

The embodiments of the present disclosure have been described above. It is possible to make various changes and modifications to the above configuration as long as it does not deviate from the gist of the present disclosure.

### [Additional Notes]

The reactor core 1 described in the embodiment is grasped as follows, for example.

(1) A reactor core 1 according to a first aspect includes an inner core region 26 that extends in a vertical direction, and has a plurality of first fuel pins 41 accommodating an inner core fuel 45A; an outer core region 25 that extends in the vertical direction, is arranged to surround the inner core region 26 from an outer peripheral side, and has a plurality of second fuel pins 42 accommodating an outer core fuel 45B; and a sodium plenum 49 provided above the inner core region 26 and the outer core region 25, in which a dimension of the outer core fuel 45B in the vertical direction is larger than a dimension of the inner core fuel 45A in the vertical direction, and the position of a center of the outer core fuel 45B in the vertical direction is higher than the position of a center of the inner core fuel 45A in the vertical direction.

Here, it is known that the peak position (that is, the position with the largest number of fast neutrons per unit area and unit time) of the fast neutron flux generated from the inner core fuel 45A and the outer core fuel 45B is the center position in the vertical direction of each core fuel. With the above configuration, the dimension of the outer core fuel 45B in the vertical direction is larger than the dimension of the inner core fuel 45A in the vertical direction. Further, the position of the center of the outer core fuel 45B is higher than the position of the center of the inner core fuel 45A. That is, the peak position of the fast neutron flux generated from the outer core fuel 45B can be maintained above the peak position of the fast neutron flux generated from the inner core fuel 45A. As a result, it is possible to secure a large amount of neutron leakage to the sodium plenum 49 positioned above the inner core fuel 45A and the outer core fuel 45B. As a result, even in a case where the temperature of the coolant is abnormally increased, a negative reactivity is generated, and the void reactivity can be suppressed to a negative value.

(2) In the reactor core 1 according to a second aspect, an upper end of the outer core fuel 45B is higher than an upper end of the inner core fuel 45A.

With the above configuration, the upper end of the outer core fuel 45B is at a position higher than the upper end of the inner core fuel 45A. That is, the peak position of the fast neutron flux generated from the outer core fuel 45B can be maintained above the peak position of the fast neutron flux generated from the inner core fuel 45A. As a result, the amount of neutron leakage to the sodium plenum 49 positioned above the inner core fuel 45A and the outer core fuel 45B can be further secured.

(3) The reactor core 1 according to a third aspect further includes a lower blanket fuel 46 that is provided inside the first fuel pin 41 to be arranged below the inner core fuel 45A.

With the above configuration, the lower blanket fuel 46 is provided below the inner core fuel 45A. That is, the dimension of the inner core fuel 45A in the vertical direction can be suppressed to be small by the amount of the lower blanket fuel 46. As a result, a sufficient height difference from the outer core fuel 45B can be secured. As a result, the peak position of the fast neutron flux generated from the outer core fuel 45B can be sufficiently shifted.

(4) In the reactor core 1 according to a fourth aspect, the first fuel pin 41 and the second fuel pin 42 have a cylindrical pin body 40H extending in the vertical direction, a plurality of fuel alloy particles 45 that are enclosed in the pin body 40H and have two types of different outer diameters, and an inert gas filled between the fuel alloy particles 45.

With the above configuration, since the fuel alloy particles 45 are used, it is not necessary to enclose sodium inside the pin body 40H. Therefore, a gas plenum (that is, a region filled with the inert gas), which is provided above the fuel alloy particles 45 in the related art, can be provided below the fuel alloy particles 45. Further, dimensions of the first fuel pin 41 and the second fuel pin 42 in the vertical direction can be suppressed to be small by the amount that the region to be filled with sodium is eliminated and the amount that the gas pressure is suppressed to be low by installing the gas plenum below the fuel alloy particles 45. As a result, the size of the reactor core 1 can be reduced.

### INDUSTRIAL APPLICABILITY

According to the present disclosure, it is possible to provide a reactor core having higher stability.

### REFERENCE SIGNS LIST

100: Fast reactor
1: Reactor core
2: Reactor vessel
3: Guard vessel
4: Coolant inlet pipe
5: Coolant outlet pipe
6: Reactor vessel pedestal
7: Upper core structure
8: Fixed plug
9: Control rod drive mechanism
10: Rotary plug
11: Rotary plug drive device
12: Core internal structure
21: Neutron shield
22: Radial blanket fuel
23: Control rod
24: Neutron source
25: Outer core region
26: Inner core region
30: Fuel assembly
31: Wrapper tube
32: Entrance nozzle
32F: Flow path
33: Handling head
40: Fuel pin
40H: Pin body
41: First fuel pin
42: Second fuel pin
43: Upper end plug
44: Upper gas plenum
45: Fuel alloy particle
45A: Inner core fuel
45B: Outer core fuel
46: Lower blanket fuel
47: Lower gas plenum
48: Lower end plug
49: Sodium plenum
50: Upper neutron shield
Ac: Axis line
H: Inlet
X: Central axis line

1. A reactor core comprising:
an inner core region that extends in a vertical direction, and has a plurality of first fuel pins accommodating an inner core fuel;
an outer core region that extends in the vertical direction, is arranged to surround the inner core region from an outer peripheral side, and has a plurality of second fuel pins accommodating an outer core fuel; and
a sodium plenum provided above the inner core region and the outer core region,
wherein a dimension of the outer core fuel in the vertical direction is larger than a dimension of the inner core fuel in the vertical direction, and the position of a center of the outer core fuel in the vertical direction is higher than the position of a center of the inner core fuel in the vertical direction.

2. The reactor core according to claim 1,
wherein an upper end of the outer core fuel is higher than an upper end of the inner core fuel.

3. The reactor core according to claim 1, further comprising:
a lower blanket fuel that is provided inside the first fuel pin to be arranged below the inner core fuel.

4. The reactor core according to claim 1,
wherein the first fuel pin and the second fuel pin have
a cylindrical pin body extending in the vertical direction,
a plurality of fuel alloy particles that are enclosed in the pin body and have two types of different outer diameters, and
an inert gas filled between the fuel alloy particles.

5. The reactor core according to claim 2, further comprising:
a lower blanket fuel that is provided inside the first fuel pin to be arranged below the inner core fuel.

6. The reactor core according to claim 2,
wherein the first fuel pin and the second fuel pin have
a cylindrical pin body extending in the vertical direction,
a plurality of fuel alloy particles that are enclosed in the pin body and have two types of different outer diameters, and
an inert gas filled between the fuel alloy particles.

7. The reactor core according to claim 3,
wherein the first fuel pin and the second fuel pin have
a cylindrical pin body extending in the vertical direction,
a plurality of fuel alloy particles that are enclosed in the pin body and have two types of different outer diameters, and
an inert gas filled between the fuel alloy particles.

8. The reactor core according to claim 5,
wherein the first fuel pin and the second fuel pin have
a cylindrical pin body extending in the vertical direction,
a plurality of fuel alloy particles that are enclosed in the pin body and have two types of different outer diameters, and
an inert gas filled between the fuel alloy particles.
